(19) United States
(12) Patent Application Publication
(10) Pub. No.: US 2010/0106713 A1
(43) Pub. Date: Apr. 29, 2010

(54) METHOD FOR PERFORMING EFFICIENT SIMILARITY SEARCH

(76) Inventors: Andrea Esuli, (US); Cristina Galeotti, (US)

Correspondence Address: Andrea Esuli, via Favilli, 3, Pisa, 56124, omitted

(21) Appl. No.: 12/565,869

(22) Filed: Sep. 24, 2009

Related U.S. Application Data
(60) Provisional application No. 61/108,943, filed on Oct. 28, 2008.

(51) Int. Cl. G06F 17/30; G06F 7/00

(52) U.S. Cl. 707/716; 707/E17.014; 707/E17.055

(57) ABSTRACT

The present invention provides systems and methods for performing efficient k-NN approximate similarity search on a database of objects. The invention is based on the definition of an index data structure that enables to have fast searches and very good scalability with respect to the database size. Such index makes efficient use of both the main and secondary memory of the computer, taking advantage of the specific properties of both kinds of memories.

A prefix tree is built on all the sequences assigned to the database objects by a sequence generation function. The prefix tree is stored in the main memory.

The information required to identify each database object and to compute the similarity between database objects and query objects are stored in a data storage kept in the secondary memory.

Given a query object and the request for the k nearest neighbors, the search functionality of the invention uses the prefix tree to quickly identify a set of candidate objects. The organization of the data storage is then used to efficiently retrieve the information relative to the candidate objects. Such information is used to compute the similarity of candidate object with the query, in order to select the k most similar ones, which are thus returned as the result.

### 1 PROVISIONAL LINK

### Related U.S. Application Data

Provisional application No. 61/108,943, filed 28 Oct. 2008, by the same inventors of the present application.

### 2 FIELD OF THE INVENTION

This invention relates generally to methods for performing similarity searches in a collection of objects. In particular the invention performs approximate k nearest neighbors analysis using a particular data index structure that permits to execute efficient and fast searches.

### 3 BACKGROUND

In a lot of modern applications is required to find, in a database, some objects similar to a given one, on the base of a degree of similarity. This problem can be solved with many advantages with similarity search methods. In these methods, to determine if an object is similar to another, a distance function is used: the smaller is the distance between two objects, the higher is their relative similarity.

More formally the problem can be expressed in the following way:
a database D contains objects from a domain [symbol] ;
a similarity distance function d: [symbol] × [symbol] → [symbol] is defined on such domain;
the similarity search process consists in retrieving the object in D that are closest to a given query object qε [symbol] , with respect to d.

The most common similarity queries can be of two types:
range queries: in this case the user gives in input the query object q and a threshold distance value t to search for the objects in D that do not exceed that threshold distance from the query;
k nearest neighbors queries (k-NN): in this case the required objects are the k closest objects in D to the query q.
   Among them, the most used query type is k-NN because the user can directly control the cardinality of the result set.

The similarity search methods can be divided into two classes:
exact methods: these are similarity search methods that guarantee that the returned result always satisfy the constraint imposed by the query;
approximate methods: such methods permit that result can contain some errors with respect to the exact case.

The simplest of the exact methods is the one that consists into scanning the whole database computing the distances between the query and the objects, sorting them by their distance, and returning the closest ones as required. A limit of such method is that the time required to return the answer is linearly proportional to the database size, making it unusable for very large databases. To speed up the resolution of similarity query several access structure have been proposed [12]. Such structures are designed to limit the number of distance computations, I/O, etc. to reduce the answer time. However, most of these structures yet suffer of limited scalability properties because of the strong constraint imposed by the requirement of producing the exact result [11].

To further reduce time cost of similarity queries, frequently with the goal of enabling a Web-scale deployment of similarity search applications, approximate similarity search techniques have been recently introduced. These techniques offer to the user a quality-time trade off, in fact if users want a prompt response to their queries, they are likely to accept results where there can be some errors with respect to the exact case. In a large number of applications this is an acceptable trade off, also considering that the results of exact methods are in fact approximated, because of the distance function used, which is an approximation of the user-perceived similarity. Most of the approximate similarity search methods proposed until now are derivation of exact similarity search methods in which some of the constraints that ensure exact results are relaxed, in order to increase the efficiency of the search process.

### 4 PRIOR ART

Chavel et al. [3], and Amato and Savino [1], have independently proposed a similarity search method based on representing any indexed object with a sequence of identifiers of reference objects, such identifiers being sorted by order of increasing distance of their relative reference objects with respect to the indexed object. The present invention is based on the same conceptual model, but it consists of completely different data structures that allow a great improvement of the efficiency of the process.

Chávez et al. [3] present an approximate similarity search method based on the intuition of “predicting the closeness between elements according to how they order their distances towards a distinguished set of anchor objects”.

A set of reference objects R={r₀, . . . , r_{|R|-1}}⊂ [symbol] is defined by randomly selecting |R| objects from D. Every object oᵢεD is then represented by a sequence sₒ_{ᵢ}, consisting of the list of identifiers of reference objects, sorted by their distance with respect to the object oᵢ.

All the sequences for the indexed objects are stored in main memory. Given a query q, all the sequences are sorted by their similarity with s_{q}, using a similarity measure defined on sequences. The real distance d between the query and the objects in the data set is then computed by selecting the objects from the data set following the order of similarity of their sequences, until the requested number of objects is retrieved. An example of similarity measure on sequences is the Spearman Footrule Distance [6]:

SFD(oₓ,o_{y})=Σ_{rεR}|P(sₒ_{ₓ},r)−P(sₒ_{_{y}},r)| (1)

where P(sₒ_{ₓ}, r) returns the position of the reference object r in the sequence assigned to sₒ_{_{x.}}

Chávez et al. do not discuss the applicability of their method to very large data sets, i.e., when the sequences cannot be all kept in main memory.

The relevant difference between the present invention and the method of [3] is that the method of [3] does not organize the sequences, and also the indexed objects, in an optimized data structure. In the method of [3], the sequences are kept in a simple vector, without a specific ordering criterion, in the main memory of the computer, and objects are similarly stored on the hard disk of the computer. This simple data organization results in a limited scalability to large collection of objects, due to the large amount of main memory required to store the sequences, and a limited efficiency, due to the non-optimized pattern of accesses to disk in order to retrieve the objects to be compared with the query.

Amato and Savino [1], independently of [3], propose an approximate similarity search method based on the intuition of representing the objects in the search space with “their view of the surrounding world”.

For each object oᵢεD, they compute the sequence sₒ_{ᵢ} in the same manner as [3]. All the sequences are used to build a set of inverted lists, one for each reference object. The inverted list for a reference object rᵢ stores the position of such reference object in each of the indexed sequences. The inverted lists are used to rank the indexed objects by their SFD value (equation 1) with respect to a query object q, similarly to [3]. In fact, if full-length sequences are used to represent the indexed objects and the query, the search process is perfectly equivalent to the one of [3]. In [1], the authors propose two optimizations that improve the efficiency of the search process, marginally affecting the accuracy of the produced ranking. One optimization consists of inserting into the inverted lists only the information related to sₒ_{ᵢ}^{k}^{ᵢ}, i.e., the part of sₒ_{ᵢ} including only the first kᵢ elements of the sequence, thus reducing by a factor

$$\vert \frac{R}{{k}_{i}} \vert$$

the size of the index. Similarly, a value kₛ is adopted for the query, in order to select only the first kₛ elements of s_{q}.

Also the present invention is based on processing only a prefix of the sequence corresponding to each indexed object. Apart from this similarity the present invention and the method of [1] are based on completely different data structures and algorithms.

Bawa et al. [2] proposed a similarity search method based on the model of local similarity hashing [8]. The LSH-Forest data structure described in [2] is based on the use of a family of locality-sensitive hash functions [symbol] , which must be defined for the distance function d.

A family [symbol] of functions from a domain [symbol] to a range U is called (r, ε, p₁, p₂)-sensitive, with r, ε>0, p₁>p₂>0, if for any p, qε [symbol] :

if d(p,q)≦r then [symbol] [h(p)=h(q)]≧p₁

if d(p,q)>r(1+ε) then [symbol] [h(p)=h(q)]≦p₂

for any hashing function h randomly selected from [symbol] .

The LSH Index [8] data structure, on which the LSH Forest is based, uses j randomly chosen functions hᵢε [symbol] to define a hash function g(x)=(h₁(x)h₂(x) . . . hⱼ(x)). Thus, if two distant objects have a probability p₂ to collide for a single hᵢ function, such probability is significantly lowered to p₂^{j} by using the g function. In order to maintain a relatively high probability of producing a collision between nearby objects, t different hash tables are built, based on randomly generated g₁ . . . gₜ functions.

Given a query object q, the various gₓ(q) hashes are computed and all the indexed objects that have at least a matching hash are considered for the computation of the real distance with the query and the inclusion in the result.

In the LSH Forest, any indexed object is given a hash key long enough to make its key unique, with a maximum length of jₘₐₓ. All the keys are grouped in a prefix tree, which is explored at search time. Given a query, the maximum length y′ of the hash gₓ(q) that has at last one match is determined, then the hash key is shortened until at least M objects in the hash table match the prefix of length y″ of the hash gₓ(q). The M objects identified in this way are retrieved from a data storage, kept on disk, in which the indexed objects are sorted in the same order they appear in the leaf of the prefix tree. This organization of the prefix tree allows to retrieve the indexed objects from disk efficiently with a sequential disk access pattern.

Although the overall organization of data structures in the present invention and in [2] is similar, i.e., a prefix tree and a sequentially structured data storage, there are relevant differences between the two methods. First, the elements denoting the node of the prefix tree are of a different nature: in the present invention the nodes of the prefix tree are denoted by the identifiers of the reference objects, while in the method of [2] the nodes of the prefix tree are denoted by the hash values returned by the various hash functions h(x)ε [symbol] . Another key difference between the present invention and the method of [2] is that the method of [2] requires a family of local similarity hash function to be defined for the domain [symbol] and the distance d in use, while the present invention has not such requirement. The present invention makes a direct use of the objects of the domain [symbol] and the distance function d. Moreover, the definition of the local similarity hash functions used by the method of [2] depends only from the distance function d, and not from the distribution of the objects in the domain [symbol] . More generally, the method of [2] does not provide any functionality that allows to optimize the method with respect to the distribution of the objects in the domain [symbol] or with respect to the distribution of the objects in the indexed database D. The present invention instead, allows to take into account the object distribution, either with respect to the whole domain [symbol] or the sole database D, by using a set of reference objects R, i.e., the elements of said set R can be selected in order to model the distribution of object into the domain or the database.

### 5 SUMMARY

The present invention provides systems and methods for performing efficient k nearest neighbors (k-NN) approximate similarity search on a database of objects.

The main contribution of the invention is the definition of an index data structure that enables to have fast searches and very good scalability with respect to the database size. Such index makes efficient use of both the main and secondary memory of the computer, taking advantage of the specific properties of both kinds of memories. The main memory is a relatively small but very fast random-access memory that allows fast access and navigation through complex data structures. The secondary memory is a permanent storage that allows to store large amounts of data. It is orders of magnitude slower than the main memory but it still guarantees good I/O performance for sequential accesses.

The part of the index data structure that is kept in main memory consists in a prefix tree. Such prefix tree is built on all the sequences assigned to the database objects by a sequence generation function ƒ_{I}. The ƒ_{I} function assigns to each database object a sequence of identifiers of length l. The identifiers univocally refer to the elements of a set of reference objects R. The elements of the R set are selected from the same domain of the elements composing the database on which the search process is performed.

The part of the index data structure that is kept in secondary memory consists in a data storage containing the information required to identify each database objects and to compute the similarity between database objects and query objects. Information in the data storage is sequentially organized in order to respect the alphabetical order of the sequences assigned to database objects.

Given a query object and the request for the k nearest neighbors, the search functionality of the invention uses the prefix tree to quickly identify a set of z candidate objects, by means of a function ƒₛ that generates a set of sequences identifying potentially similar objects. The organization of data in the data storage is then used to efficiently retrieve the information relative to the candidate objects. Such information is used to compute the similarity of candidate objects with the query, in order to select the k most similar ones, which are returned as the result.

In the following we detail the structure of the index, how the invention realizes the similarity search functionality by using the index, and how to efficiently build the index. An example of a practical embodiment is presented in order to show a complete realization of the invention. Other possible embodiments and enhancements to the invention are discusses in order to give a broader view on additional aspects, applications and advantages of the invention.

### 6 DRAWINGS

The invention will now be described in more detail, by way of example only, with reference to the accompanying drawings, in which:

FIG. 1 is a pseudocode description of the BUILDINDEX function that is used to build the index structure.

FIG. 2 is a pseudocode description of the SEARCHINDEX function that is used to perform the similarity search.

FIG. 3 is a pseudocode description of a possible implementation of the ƒ_{I} function that is used by the invention at indexing time.

FIG. 4 is a pseudocode description of a possible implementation of the ƒ_{S} function that is used by the invention at search time.

FIG. 5 shows an example of possible sequences generated for objects in a database D, given some index characteristics.

FIG. 6 shows an abstract representation of a partially-built index data structure after the first phase of insertion of sequences into the prefix tree has been completed, before the data storage reordering. Data in this figure refers to sequences listed in FIG. 5.

FIG. 7 shows an abstract representation of a complete index data structure, after the data storage reordering phase. Data in this figure refers to sequences listed in FIG. 5.

FIG. 8 shows abstract representation of the index data structure of FIG. 7 with the only-child paths to leaves pruning strategy applied. Data in this figure refers to sequences listed in FIG. 5.

FIG. 9 shows abstract representation of the index data structure of FIG. 8 with the only-child paths compression strategy applied. Data in this figure refers to sequences listed in FIG. 5.

It is to be noted, however, that the appended drawings illustrate only typical embodiments of this invention and are therefore not to be considered limiting of its scope, for the invention may admit to other equally effective embodiments.

### 7 DESCRIPTION OF THE INVENTION

This section describes the data structures defined by the invention, the input values taken by the invention to build and access such data structures, and how the data structures are used to provide an efficient similarity search functionality.

### 7.1 Data Structures

This section describes the data structure, i.e. the index, defined by the invention.

The invention allows to perform approximate k-NN similarity search on a database D of objects belonging to a domain [symbol] , on the base of a distance function d: [symbol] × [symbol] → [symbol] .

In order to build the index, the invention takes in input a set of reference objects R, belonging to the domain [symbol] , where each object rεR is identified univocally by a number that goes from 0 to #R−1, where the #X operator returns the number of elements in the set X, that is R={r₀, r₁, . . . , r_{#R-1}}.

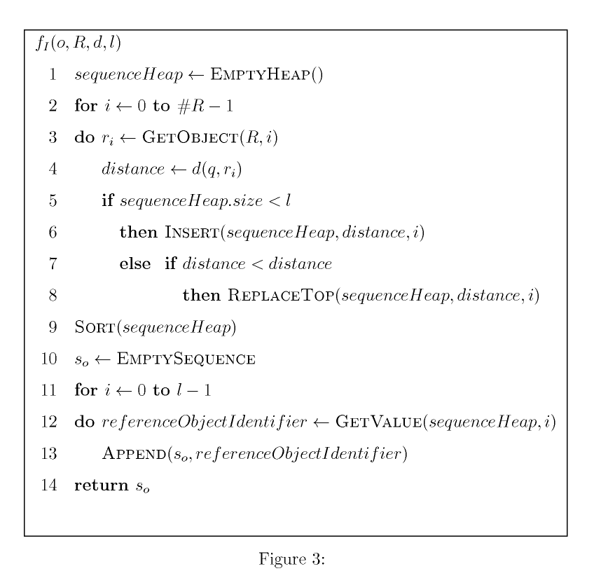

The invention uses a function ƒ_{I}(o, R, d, l) (FIG. 3) that, given an element oε [symbol] , the set of reference objects R and the distance function d, returns a sequence sₒ, of a length l. The returned sequence consists in the identifiers of the l nearest reference objects to the object o, measured by using the distance function d. The identifiers in the sequence are ordered on the base of the distance of the reference objects from o, from the nearest to the farthest.

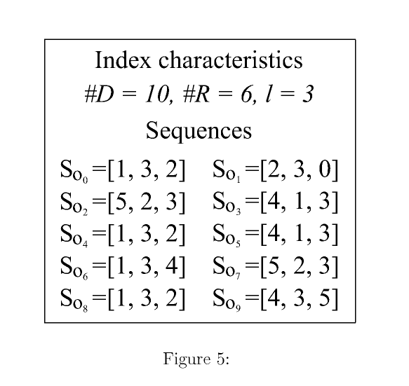

For example, given a set R containing at least 4 reference objects {r₀, r₁, r₂, r₃, . . . }, and a value l=3 a possible output of the function ƒ_{I} can be ƒ_{I}(o, R, d, l)=sₒ=[2, 3, 0], thus listing, in order of their distance d(o, rₓ), the identifiers of the reference objects r₂, r₃ and r₀ (see FIG. 5 for more examples).

The indexing algorithm uses ƒ_{I} to assign a sequence sₒ_{ᵢ}, to each object oᵢεD. All the sequences are stored in a prefix tree [7] that is kept in the main memory. Each internal node of the prefix tree contains a list of child nodes, each one referring to a different reference object identifier. Thus, the root node of the prefix tree contains the list of child nodes referring to all the reference object identifiers appearing at least once in the first position of the indexed sequences. Each of such child nodes keeps the information related to reference object identifiers appearing in the second position of the sequences, and so on for l levels of depth. Finally, each leaf of the prefix tree contains the information on how to retrieve all the core data (defined below) relative to indexed objects oₓ for which ƒ_{I}(oₓ, R, d, l) is equal to the sequence determined by the reference object identifiers assigned to the nodes in the path from the root of the prefix tree to the leaf itself.

The core data of an object oᵢ consist in the essential information required to uniquely identify the object and to compute the distances with other objects in [symbol] . The core data of each indexed object is stored sequentially in a persistent data storage, kept in secondary memory.

The sequence of core data entries in the data storage is organized such that the core data of objects represented by the same sequence s are written in adjacent positions, forming a group gₛ. All the groups are ordered in the data storage following the alphabetical order of the sequences, based on the alphabet defined by the reference objects identifiers.

Given two pointers pₒ_{ᵢ} and pₒ_{_{y}} to the data storage, pointing to the core data relative to two objects oᵢ and o_{y}, the data storage must allow to read sequentially all the core data entries stored between them. Leveraging on this property of the data storage, the leaf of the prefix tree corresponding to a sequence s can identify the core data entries of a whole group of objects gₛ with just two pointers pₛ^{start} and pₛ^{end} to the data storage, relatively to the first and to the core data entries of the group gₛ. Sections 8 and 9 describe examples of implementation of the data storage.

### 7.2 Similarity Search Functionality

The search function is designed to use the index to efficiently answer to k nearest neighbors queries. A k-NN query is composed by:
1. the query object q;
2. the value k, which indicates the number of requested nearest neighbors;
3. the value z, which indicates the minimum number of candidate objects among which the k nearest neighbors have to be selected.

The search algorithm is based on the iterative invocation of a function ƒ_{S}(q, S, R, d, l), which takes in input the query object qεØ, a set of sequences S, whose length is ≦l. the set of reference objects R and the distance function d used to build the index, the length of the indexed sequences l. The function returns a new set of sequences S′, whose length is still ≦l.

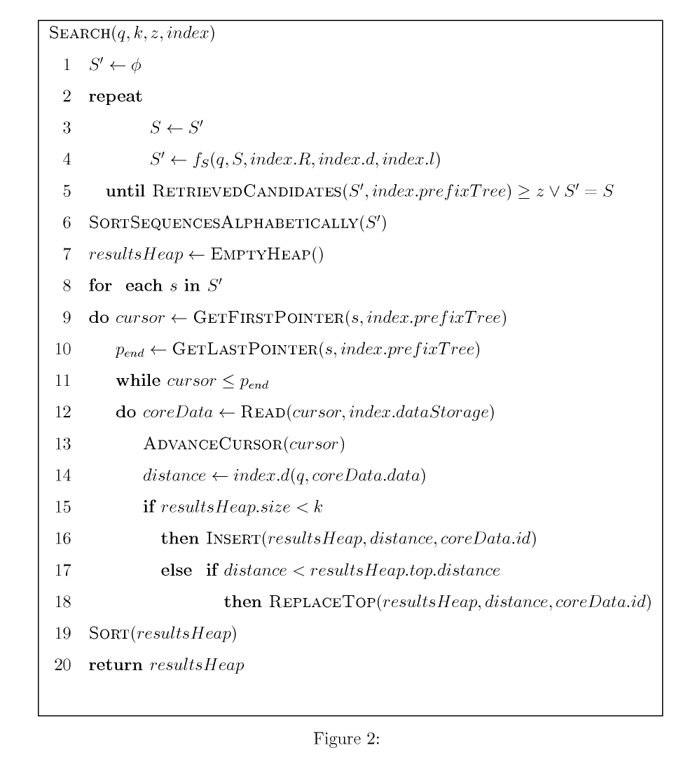

During the first phase of the search process the function ƒₛ is called iteratively until the set of sequences S^{x}, after x iterations, identifies at least z candidate objects, or no more candidate objects can be found (FIG. 2, lines 1-5).

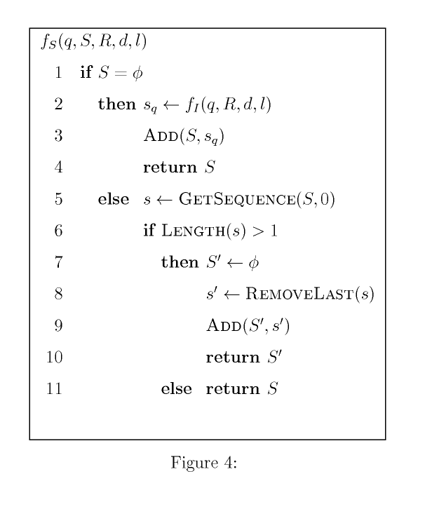

In detail, the ƒ_{S} function is defined as follows (FIG. 4):
The first call takes in input q and an empty set φ, and returns a sequence set containing only the sequence s_{q} calculated applying the function ƒ_{I} to q.
The i-th call takes the sequence contained in the sequence set Sⁱ⁻¹ returned by the previous iteration and removes its last element. The shortened sequence is thus able to identify a larger set of candidates. A set Sⁱ containing only the shortened sequence is returned.

After l calls, when the sequence in the set S^{l} reaches a length m=1, the function ƒ_{S} returns a sequence set S^{l+1} equal to S^{l}, thus stopping the search for candidates.

The number of candidate objects zⁱ, retrieved by the sequence set Sⁱ, is computed by adding the number of objects retrieved by each sequence sεSⁱ. An object oεD is retrieved by a sequence s of length m≦l if s has a prefix match with ƒ_{I}(o, R, d, l). This means that a sequence s retrieves all the objects pointed by all the leaves of the subtree of the prefix tree rooted at the end of the path described by s. In the case that the prefix tree does not contains a path matching s the sequence s is considered to retrieve no objects.

The number of objects retrieved by a sequence s′ of length l can be efficiently determined by storing in the corresponding leaf node of the prefix tree the ordinal positions h_{s′}^{start} and h_{s′}^{end} in the data storage respectively of the first and last core data entries of the group g_{s′}. The difference between the two ordinal positions plus one is equal to the number of objects in the group.

The number of objects retrieved by a sequence s″ of length m<l can be efficiently determined by looking for the path in the prefix tree exactly matching s″, and then descending the prefix tree:
1. iteratively looking for the child represented by the smallest reference object identifier and then, when a leaf is reached, looking for the ordinal position hₛ_{ₓ}^{start} of the first core data entry of the group gₛ_{ₓ}; sₓ is actually the alphabetically first sequence of all the indexed sequences that has a prefix match with s″.
2. iteratively looking for the child represented by the largest reference object identifier and then, when a leaf is reached, looking for the ordinal position hₛ_{_{y}}^{end} of the last core data entry of the group gₛ_{_{y}}; s_{y} is actually the alphabetically last sequence of all the indexed sequences that has a prefix match with s″.

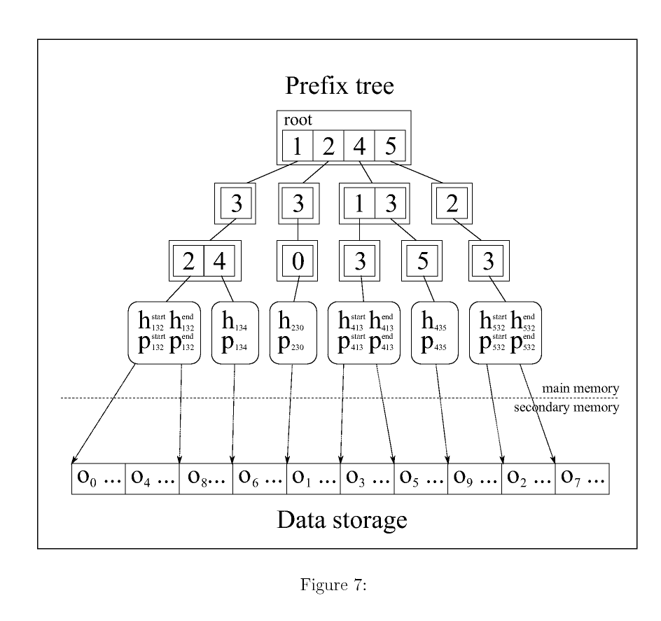

The difference between the two ordinal positions plus one is equal to the number of objects retrieved by s″, and the two relative pointers pₛ_{ₓ}^{start} and pₛ_{_{y}}^{end} can be used to actually access the data storage and read the relevant core data entries. In the case that a sequence sⱼ has been assigned to a single object, two single hₛ_{ⱼ}, and pₛ_{ⱼ} values are stored in the corresponding leaf node of the prefix tree, with the assumption that hₛ_{ⱼ}^{start}=hₛ_{ⱼ}^{end}=hₛ_{ⱼ} and pₛ_{ⱼ}^{start}=pₛ_{ⱼ}^{end}=pₛ_{ⱼ} (see the values in the leaves of the prefix tree in FIG. 7).

The second phase of the search process (FIG. 2, lines 6-20) consists in:
1. retrieving the core data entries for candidate objects from the data storage, with a sequential reading of the identified candidates, and also following the alphabetical order of sequences in S^{x};
2. computing the distance of each candidate object with the query, by using the distance function d.
   A heap [5] can be used to keep track of which are the top k closest objects to the query. Only at the end those k objects are completely sorted by their distance and returned as the result.

It is relevant to note that the z value plays a key role into the determination of the quality-cost trade off. The quality of results is affected by the z value because it determines the size of the pool of candidates from which the final approximated k-NN result is computed: the larger is the z value, the larger is the probability for the approximated result to match the exact result. The cost of obtaining results is affected by the z value because it determines the amount of I/O from the data storage, i.e., the number of data entries to be read, and the number distance calculations.

### 8 PRACTICAL EMBODIMENT

After the description of the main components that characterize and define the invention, the following describes a practical embodiment in which all the parameters of the invention are set in order to develop a practical application. It is obvious to one of ordinary skill in the art that the following, including Sections 8.1 and 8.2, is just one of possible embodiments of the invention, chosen as an example to fully present a practical realization of the invention.

In the case under study the method is used to perform a similarity search on a database D of 10 millions of images crawled from the Web. In general the present invention finds application in any context where a similarity search functionality over a database of objects is required, thus the nature of the domain [symbol] can vary. For example, but not limiting the possible domain types to the following list, other possible domains can be music, blog posts, photographic portraits, three dimensional models, genetic sequences, customers profiles, Internet browsing histories.

Images are compared for their similarity by comparing their HSV color histograms [4]. The HSV color space is divided into 32 subspaces (8 ranges of H×4 ranges of S). The color histogram for a given image consists in the sequence of densities of color for each subspace, computed on the entire image. Thus the core data for an image consists in an integer identifier i and the 32 double values describing the color histogram vector vᵢ, with a resulting core data entry size of 260 bytes.

Generally the features used to represents objects in the similarity search task may vary, both due to the original domain [symbol] and the specific kind of similarity notion under investigation. For example, but not limiting the possible feature definitions to the following list, the invention can use features represented by HSV histograms, geometric shapes, bag of words, MPEG-7 audio or visual descriptors, strings, URL sets, wavelet transforms.

The distance function d used to compare images is the Manhattan distance applied to their respective HSV histogram vectors: d(x, y)=Σᵢ₌₀³¹|vₓ[i]−v_{y}[i]|.

In general the choice of the distance function, similarly to the choice of the object features, may vary, both due to the specific features in use and the specific kind of similarity notion under investigation. For example, but not limiting the possible distance function definitions to the following list, the invention can use as the distance function: the Euclidean distance, the Jaccard distance, the Hamming distance, the Levenshtein distance, the Kullback-Leibler divergence.

The data storage, which contains all the information associated to each object in D, is implemented in a binary file in which the core data entries are written sequentially.

Given that the core data entries used in the application we are describing have a fixed size, the list of pointers into the leaves of the tree can be simplified to just store the ordinal position in the storage of the first and the last core data entries of the group gₛ relative to a sequence s, i.e., hₛ^{start} and hₛ^{end}. The hₛ^{start} value can be used to access the first the core data entry in the storage file, by accessing the file at the pₛ^{start}=260·hₛ^{start} byte offset. Then all the core data entries in the group can be read by sequentially reading 260 byte blocks until the offset value is equal to pₛ^{end}=260·hₛ^{end}. The number of core data entries included by the two pointers is hₛ^{end}−hₛ^{start}+1.

The reference objects set R is defined by randomly selecting 100 objects from D.

The length of the sequences sₒ is fixed as l=6.

### 8.1 Building the Index

For the example embodiment described above, this section describes how the structure of data index can be built efficiently.

As mentioned above, the following is provided just to show the possibility of realizing an efficient implementation of the method. Given different realizations of the components of the method, e.g. a data storage implemented using a database management system (DBMS), other efficient implementations of the indexing algorithm are possible, still not departing from the spirit of the invention.

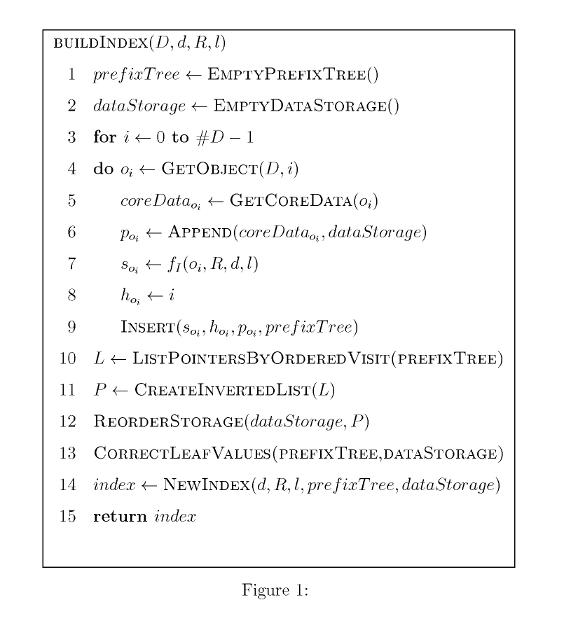

The indexing algorithm initializes an empty prefix tree in main memory, and an empty file on disk, to be used as the data storage (FIG. 1, lines 1-2).

To build the index, the algorithm takes in input the HSV histogram for an image object oᵢεD, for i going from 0 to #D−1, and writes its core data entry in the data storage file, starting from the byte position pₒ_{ᵢ}=260·i. Then the algorithm computes, for the object oᵢ, the sequence sₒ_{ᵢ}, using the function ƒ_{I}, and inserts sₒ_{ᵢ}, in the prefix tree. The value hₒ_{ᵢ}=i is stored in the leaf of the prefix tree that corresponds to the sequence sₒ_{ᵢ}. When more that one value has to be stored in a leaf, a list is created. This operation is performed for each object of D (FIG. 1, lines 3-9). Given that i goes from 0 to #D−1, the accesses to the data storage to write core data entries are completely sequential.

The next step consists in sorting the core data entries in the data storage to satisfy the ordering constrains described in the previous section. To do this, the first step consists in performing an ordered visit of the prefix tree in order to produce a list L of the hₒ_{ᵢ} values stored in the leaves (FIG. 1, line 10). The visit of the prefix tree is performed in a depth first [5] manner following the cardinal order of the reference object identifiers. Thus, the hₒ_{ᵢ} values in the list L are sorted by the alphabetical order, based on the alphabet of reference object identifiers, of the sequences their relative objects are associated to.

Core data entries in the data storage are reordered following the order of appearance of hₒ_{ᵢ} values in the list L.

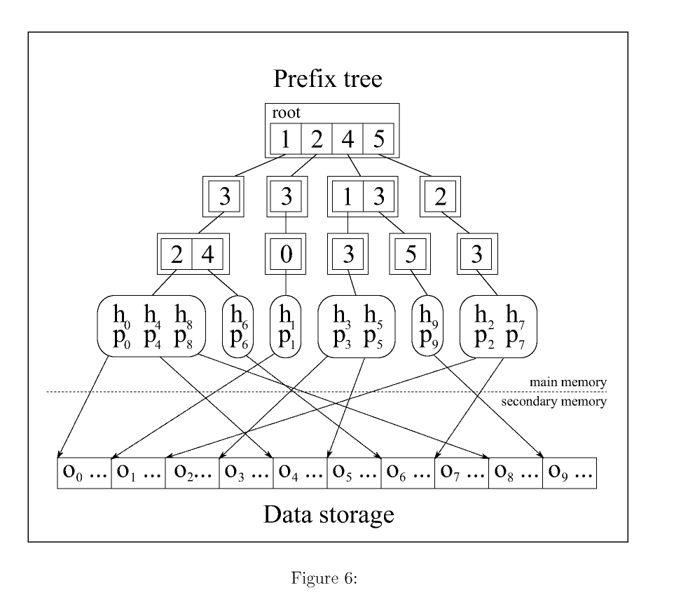

For example, given a list for L=[0, 4, 8, 6, 1, 3, 5, 9, 2, 7], the core data entry relative to the object o₇, identified in the list by the value hₒ_{₇}=7, has to be moved to the last position in the data storage, since hₒ_{₇} appears in the last position of the list L (see the values in the leaves of the prefix tree in FIG. 6).

The reordering operation is a potential bottleneck of the indexing process. A naïve implementation of the data storage reordering function, consisting in writing sequentially the new version of the data storage, actually generates #D random read accesses to the original version of the data storage. Similar is the opposite situation where the original data storage is read sequentially and the new reordered data storage is thus generated by #D random write accesses.

To efficiently perform the reordering, the list L is inverted into a list P (FIG. 1, line 11). The i-th position of the list P indicates the new position where the i-th element of the data storage has to be moved.

For example, given the list L previously described, the corresponding list P is P=[0, 4, 8, 5, 1, 6, 3, 9, 2, 7].

The list P could be efficiently generated in the following way:
1. the list P is initialized with an ordered numbering starting from 0: P=[0, 1, 2, 3, 4, 5, 6, 7, 8, 9];
2. both P and L are sorted in order to produce an ascending sorting of the values in L. Obtaining, for the above example, L=[0, 1, 2, 3, 4, 5, 6, 7, 8, 9], P=[0, 4, 8, 5, 1, 6, 3, 9, 2, 7].

Once the P list is generated the data storage is reordered accordingly (FIG. 1, line 12), using an m-way merge [9] sorting method:
1. the data storage is read sequentially in segments of a size that can be processed in main memory, e.g., 1,000 elements;
   (a) each segment is reordered in memory following the ordering information contained in the respective segment of the P list, and then written sequentially to the secondary memory;
2. the original data storage is deleted;
3. groups of m segments are merged together in a larger segment, following the final order the core data entries have to respect;
4. after each merge step, the segments being merged are deleted;
5. the previous two operations are repeated until only one segment remains, which is the final reordered data storage.

If the database D is very large, also the lists L and P can require more main memory than the one actually available on the hardware processing the data. This issue can be easily overcome by applying the m-way merge sorting strategy to their sorting.

The advantage of using this reordering method is that it involves only sequential accesses to the secondary memory, and that the maximum requirement in terms of main memory space is defined by the size of the segments during the initial ordering phase. The maximum requirement in terms of secondary memory space is equal to two times the size of the complete data storage, given that at the end of the initial block-ordering phase, and at the end of the last merge iteration, the data is perfectly duplicated.

In order to obtain the final index structure, the values in the leaves of the prefix tree have to be updated accordingly to the new data storage (FIG. 1, line 13).

This is obtained by performing a synchronized depth first visit to the prefix tree, the same performed when building the list L, and a sequential scan of the reordered data storage. The number of elements listed in a leaf determines the number of core data entries to be read from the data storage and also the h^{start} and h^{end} values. Core data entries are read from the data storage in order to determine the p^{start} and p^{end} values.

In the specific case under examination, given that the pₛₜₐᵣₜ and p_{end} values can be directly derived from the h^{start} and h^{end} values, the sequential scan of the data storage is not required, thus reducing the data processing required to perform the prefix tree update to its depth first visit.

### 8.2 Searching the Index

For the example embodiment described above, this section describes how the similarity search functionality can be realized using the invention.

Again, the following is provided just to show the possibility of realizing an efficient realization of the invention. Given different realizations of the components of the method, other efficient realizations of the similarity search functionality are possible, still not departing from the spirit of the invention.

The search algorithm, described in Section 7.2, takes in input a query q. The query consists in a color histogram v_{q}, built the same way as those of the indexed images. The values of k and z are set to 100 and 1000, respectively.

The function ƒ_{S} is invoked until the sequence set S^{x}, returned at the x-th iteration, identifies at least z candidates, or it is equal to S^{x-1}. Once the ƒ_{S} function has returned a final set of sequences S, all the core data entries included by the sequences are sequentially retrieved from the data storage.

The core data entries included by a sequence s′ of length l can be efficiently retrieved from the data storage by reading the values h_{s′}^{start} and h_{s′}^{end} stored in the leaf node of the prefix tree for the group relative to the sequence gₛ and then sequentially reading the core data entries from the data storage starting from the file offset p_{s′}^{start}=260·h_{s′}^{start} until the file offset p_{s′}^{end}=260·h_{s′}^{end} is reached.

In the case of a sequence s″ of length m<l, the included core data entries can be efficiently retrieved from the data storage by looking for the path in the prefix tree exactly matching s″, and then descending the prefix tree:
1. iteratively looking for the child represented by the smallest reference object identifier and then, when a leaf is reached, looking for the value hₛ_{ₓ}^{start}; sₓ is actually the alphabetically first sequence of all the indexed sequences that has a prefix match with s″.
2. iteratively looking for the child represented by the largest reference object identifier and then, when a leaf is reached, looking for the pointer hₛ_{_{y}}^{end}; s_{y} is actually the alphabetically last sequence of all the indexed sequences that has a prefix match with s″.

The core data entries are then read from the data storage by sequentially accessing it starting from the file offset pₛ_{ₓ}^{start}=260·hₛ_{ₓ}^{start} until the file offset pₛ_{_{y}}^{end}=260·hₛ_{_{y}}^{end} is reached.

In the case that the prefix tree does not contains a path matching a sequence s, the sequence is considered to retrieve no objects.

In the case that the S^{x} set contains more than one sequence, the sequences can be alphabetically sorted. Core data entries are retrieved from data storage following also such sequences order, in order to maximize the sequentiality of file accesses.

Each core data entry read from the data store is used to determine the identifier of the object oᵢ associated to it and to compute its distance d(q, oᵢ) with the query. A heap is used to efficiently maintain the set of the identifiers of the k nearest objects during the sequential accesses to candidate core data entries. Once all the candidate core data entries have been processed, the identifiers of the objects, which are partially sorted in the heap, are sorted according to their distance from the query and such ordered list is returned as the result.

### 9 OTHER EMBODIMENTS AND ENHANCEMENTS

Having now fully described the invention, it will be apparent to one of ordinary skill in the art that many changes and modifications can be made thereto without departing from the spirit or scope of the invention as set forth herein. What is discussed in the following sections is not intended to be a complete discussion of all the possible embodiments and enhancements applicable to the invention, but just a discussion on some specific elements of the invention, aimed to give a better description of it.

### 9.1 Definition of the R Set

The definition of optimal methods for the selection of the elements in the set R is beyond the scope of the present invention. However, it is evident to the one of ordinary skill in the art that a basic policy consists into building the R set with randomly selected elements of D. The effect of the random selection policy is to create a set R that has a distribution similar to D with respect to the distance function d. This random selection policy has to be considered the default policy for the present invention, and thus an integral part of it.

Two other more elaborated policies could be based on defining R by selecting the medoids of #R clusters of D, obtained by applying a clustering method to elements of D, or selecting the outliers of D, i.e., the elements which are more isolated from all the others.

Another possibility is to generate synthetic elements of [symbol] in order to produce a set R whose elements have some particular properties, e.g., uniform distribution with respect to the specific distance function d in use.

### 9.2 Definition of the ƒ_{I} and ƒ_{S} Functions

The present invention is based on the ƒ_{I} and the ƒ_{S} functions, which are respectively used during the indexing and searching processes. The definitions of the ƒ_{I} and ƒ_{S} functions can be changed on the base of a different quality-cost trade off.

For example, the invention can be easily adapted in order to use a function ƒ′_{I} that generates more than one sequence for each indexed object. This can by done by selecting some random permutations of the sequence generated by the original ƒ_{I} function, thus inserting the same object in multiple locations of the prefix tree. This ƒ′_{I} function has thus the goal of increasing the recall of the search process, at the expenses of having a larger index with some replicated information.

Similarly a ƒ′_{S} function can be formulated in order to add to the sequence set more sequences based on permutations of the original ƒ_{S} function. Again this ƒ″_{S} trades the possibility of a wider search with the higher cost of more sparse accesses to the data storage.

### 9.3 Implementation of the Data Storage

Core data entries may be of variable sizes, for example in the case the objects in D are documents represented using a bag-of-words model and a sparse representation is used. In that case, when using a data storage implemented with a binary file, as in the example of section 8, the leaves of the prefix tree have to store both the file offset pointer and the ordinal position of each of the indexed object during the first phase of indexing process, and then just keeping such information for the first and last core data entry of each group, in the final version of the prefix tree.

Data storage could be implemented with a different technology than binary files, e.g., using a database management system (DBMS). The practical realization of some elements of the method, e.g., the data storage reordering, will have to take into account the specific functionalities provided by the technology used to implement the data storage.

### 9.4 Prefix Tree Optimizations

In order to reduce the main memory occupation of the prefix tree it is possible to simplify its structure without any effect on the quality of results.

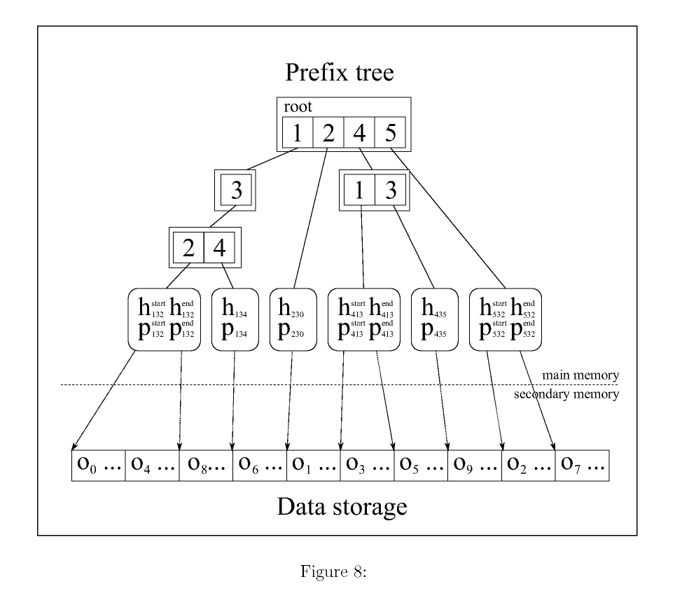

A first simplification consists into pruning any path reaching a leaf which is composed by only-child. The evident motivation for this simplification is that a path of such kind does not add relevant information to distinguish between different existing groups in the index. FIG. 8 shows the result of applying this simplification to the prefix tree of FIG. 7.

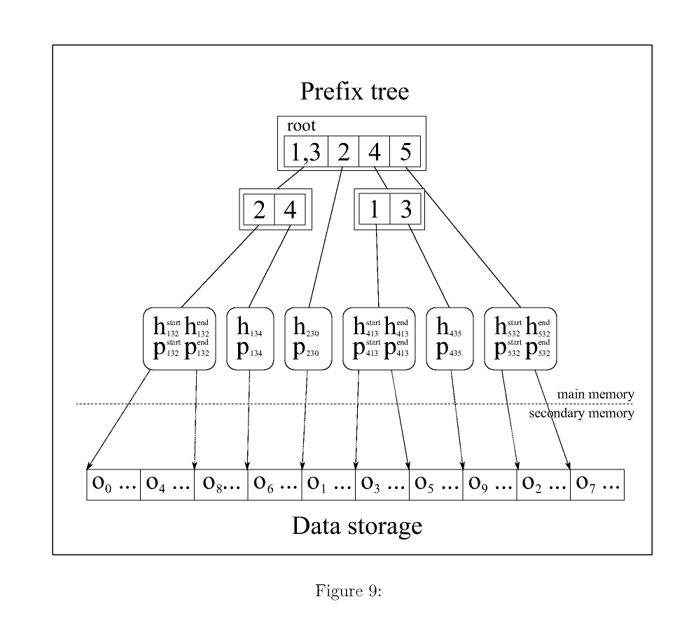

Another simplification consists into compressing any path of the prefix tree that is composed by only-child into a single label [10], thus saving the memory space required to keep the chain of nodes composing the path. FIG. 9 shows the result of applying this simplification to the prefix tree of FIG. 8.

Another simplification, applicable when the z value is hardcoded into the search function, consists in merging the subtrees of the prefix tree whose leaves globally points to less than z objects in the data storage, where z is the number of candidate objects to be retrieved during search. This is motivated by the fact that the ƒ_{S} function actually searches for the smallest subtree of the prefix tree that has a prefix match with s_{q} and points to at least z objects. Thus, the information contained in smaller subtrees is not useful and can be removed. The merge process of the subtrees consists in identifying the first core data entry of the first group and the last core data entry of the last group pointed by the subtree and replacing the subtree root node with a leaf node that has the h and p values pointing to those two core data entries.

### REFERENCES

[1] G. Amato and P. Savino. Approximate similarity search in metric spaces using inverted files. In INFOSCALE '08: Proceeding of the 3rd International ICST Conference on Scalable Information Systems, pages 1-10, Vico Equense, Italy, 2008.
[2] M. Bawa, T. Condie, and P. Ganesan. Lsh forest: self-tuning indexes for similarity search. In WWW '05: Proceedings of the 14th international conference on World Wide Web, pages 651-660, Chiba, Japan, 2005.
[3] E. Chávez, K. Figueroa, and G. Navarro. Effective proximity retrieval by ordering permutations. IEEE Transactions on Pattern Analysis and Machine Intelligence (TPAMI), 30(9):1647-1658, 2008.
[4] Corel Image Features. http://archive.ics.uci.edu/ml/databases/CorelFeatures/CorelFeatures.data.html.
[5] T. H. Cormen, C. E. Leiserson, and R. L. Rivest. Introduction to algorithms. MIT Press and McGraw-Hill, 1990.
[6] P. Diaconis. Group representation in probability and statistics. IMS Lecture Series, 11, 1988.
[7] E. Fredkin. Trie memory. Commun. ACM, 3(9):490-499, 1960.
[8] P. Indyk and R. Motwani. Approximate nearest neighbors: towards removing the curse of dimensionality. In STOC '98: Proceedings of the 30th ACM symposium on Theory of computing, pages 604-613, Dallas, USA, 1998.
[9] D. Knuth. The Art of Computer Programming, chapter Section 5.4: External Sorting, pages 248-379. Addison-Wesley, second edition edition, 1998.
[10] D. R. Morrison. Patricia—practical algorithm to retrieve information coded in alphanumeric. J. ACM, 15(4):514-534, 1968.
[11] M. Patella and P. Ciaccia. The many facets of approximate similarity search. SISAP '08, First International Workshop on Similarity Search and Applications., pages 10-21, April 2008.
[12] P. Zezula, G. Amato, V. Dohnal, and M. Batko. Similarity Search: The Metric Space Approach (Advances in Database Systems). Springer, 2005.

The embodiments of the invention in which the inventors claim an exclusive property or privilege are defined as follows:

1. A method embodied on a computer readable medium for retrieving k approximate nearest neighbors, with respect to a query object and a distance function, from a data set having a plurality of objects, comprising:
using a set of uniquely identified reference objects selected from the same domain of the objects of said data set;
using a computer to implement the steps of
representing each object of said data set and said query object with a sequence of identifiers of the l closests objects belonging to said set of reference objects, measuring the distance between any object of said data set and any object of said set of reference objects using said distance function;
maintaining a prefix tree to organize said sequences;
maintaining a data storage to organize the data entries representing all the object in said data set, wherein a data entry stores the information required to compute the distance of the object it represents, using said distance function, with respect to any other object in the domain;
maintaining in every leaf of said prefix tree the pointers to the locations of said data storage containing the data entries relative to the objects of said data set that are represented by the sequence identified by the path going from the root of said prefix tree to said leaf;
maintaining the data entries in said data storage sequentially sorted in the order resulting from performing a depth first visit of said prefix tree;
using said prefix tree to identify a set of at least z objects of said data set whose representing sequences have the longest possible prefix match with the sequence representing said query object;
using the pointers in the leaves of said prefix tree to retreive all the data entries associated to said candidate objects;
using the data entry of each object in said set of candidate objects to compute the distance, using said distance function, with respect to said query object;
selecting the k nearest objects in said set of candidate objects, with respect to said query object, as the approximate k nearest neighbors search result.

2. The method of claim 1, wherein said set of reference objects is defined by randomly sampling the objects of said data set.

3. The method of claim 1, wherein said set of reference objects is defined by randomly sampling the objects a different data set, which may have a non-empty intersection with the data set being indexed.

4. The method of claim 1, wherein said set of reference objects is defined by selecting relevant objects from a log of query objects used in previous nearest neighbor searches.

5. The method of claim 1, wherein some of the objects of said data set are represented by more than one sequence, generating the additional sequences by permutating some of the elements of the original sequence representing each of said objects.

6. The method of claim 1, wherein more than one set of candidate objects is identified by representing the query object with more than one sequence, generating the additional sequences by permutating some of the elements of the original sequence representing said query object.
